(19) United States
(12) Patent Application Publication
(10) Pub. No.: US 2025/0130175 A1
(43) Pub. Date: Apr. 24, 2025

(54) OPTICAL INSPECTION APPARATUS, OPTICAL INSPECTION METHOD, AND NON-TRANSITORY STORAGE MEDIUM STORING OPTICAL INSPECTION PROGRAM

(71) Applicant: KABUSHIKI KAISHA TOSHIBA, Tokyo (JP)

(72) Inventors: Hideaki OKANO, Yokohama Kanagawa (JP); Hiroshi OHNO, Tokyo (JP); Takahiro KAMIKAWA, Yokohama Kanagawa (JP); Hiroya KANO, Kawasaki Kanagawa (JP); Kenta TAKANASHI, Kawasaki Kanagawa (JP)

(73) Assignee: KABUSHIKI KAISHA TOSHIBA, Tokyo (JP)

(21) Appl. No.: 18/773,997

(22) Filed: Jul. 16, 2024

(30) Foreign Application Priority Data
Oct. 23, 2023 (JP) 2023-181985

(51) Int. Cl. G01N 21/88; G01N 21/47

(52) U.S. Cl. CPC G01N 21/8806; G01N 21/47; G01N 2201/0635

(57) ABSTRACT

According to an embodiment, an optical inspection apparatus includes a controller. The controller is configured to: project first modulation pattern lights having an intensity modulation pattern, in which an extending direction of an end portion of an object and a modulation direction are substantially parallel, onto the object; acquire a first image group by imaging the object onto which the first modulation pattern lights are projected; and generate, by a peculiar scattering extraction process, a first peculiar light scattering image that is able to include an image of a peculiar area that is located at the end portion of the object or in an area inside the end portion, is extracted based on the first image group, and causes peculiar light scattering due to the first modulation pattern lights.

### CROSS-REFERENCE TO RELATED APPLICATIONS

This application is based upon and claims the benefit of priority from Japanese Patent Application No. 2023-181985, filed Oct. 23, 2023, the entire contents of all of which are incorporated herein by reference.

### FIELD

Embodiments described herein relate generally to an optical inspection apparatus, an optical inspection method, and a non-transitory storage medium storing an optical inspection program.

### BACKGROUND

In various industries, it has become important to perform an optical inspection of an object in a noncontact manner. As a noncontact optical inspection method, there is known pattern projection imaging in which, for example, pattern lights having a spatial intensity modulation represented by a trigonometric function are successively projected onto an object, and the object is imaged each time, thereby acquiring properties and condition of the object from a plurality of images obtained by photography. However, there is a case in which an alias signal occurs at an end portion of the object due to the influence of light reflection by the end portion.

### BRIEF DESCRIPTION OF THE DRAWINGS

FIG. 1 is a diagram illustrating a configuration of an optical inspection apparatus that is an example according to a first embodiment.

FIG. 2 is a diagram illustrating an example of a hardware configuration of a control device.

FIG. 3A is a diagram illustrating, in an overlapping manner, four pattern lights having phases displaced by λ/4, which are projected onto a projection surface of an object.

FIG. 3B is a diagram illustrating an example of light on an object surface, which corresponds to the projection of four pattern lights illustrated in FIG. 3A.

FIG. 3C is a diagram illustrating an example of an amplitude image generated by using an image captured by photographing the light on the object surface of FIG. 3B corresponding to the projection of pattern lights of FIG. 3A.

FIG. 4 is a schematic perspective view illustrating an example of an object that is optically inspected by the optical inspection apparatus according to the first embodiment.

FIG. 5A is a diagram illustrating a scattering image (first peculiar light scattering image) in a case where a modulation direction of pattern lights at a position including an end portion indicated by reference sign V in FIG. 4 is substantially parallel to an extending direction of the end portion of the object.

FIG. 5B is a diagram illustrating a scattering image (second peculiar light scattering image) in a case where a modulation direction of pattern lights at the position including the end portion indicated by reference sign V in FIG. 4 is nonparallel to the extending direction of the end portion of the object.

FIG. 6 illustrates an example of a peculiar light scattering image in a case where a peculiar area (defect) is present at the end portion of the object and a vicinity thereof.

FIG. 7 is a flowchart illustrating a process by an optical inspection program that is executed by using the optical inspection apparatus according to the first embodiment.

FIG. 8 is a flowchart illustrating a subroutine of step S11 illustrated in FIG. 7.

FIG. 9 is a flowchart illustrating a process by an optical inspection program that is executed by using the optical inspection apparatus according to the first embodiment.

FIG. 10 is a schematic diagram illustrating an object that can be a target of an inspection by an optical inspection apparatus according to a first modification of the first embodiment, pattern lights used at a time of inspecting the object, and a modulation direction of the pattern lights.

FIG. 11 is a diagram illustrating a configuration of an optical inspection apparatus that is an example according to a second modification of the first embodiment.

FIG. 12 is a flowchart illustrating a process by an optical inspection program that is executed by using the optical inspection apparatus according to the second modification of the first embodiment.

FIG. 13A is a diagram schematically illustrating the area indicated by reference sign V in FIG. 4 of a peculiar light scattering image generated by using pattern lights (second modulation pattern lights) that are nonparallel to the extending direction of the end portion of the object, and an inspection target area in the peculiar light scattering image.

FIG. 13B is a diagram schematically illustrating the area indicated by reference sign V in FIG. 4 of a peculiar light scattering image generated by using pattern lights (second modulation pattern lights) that are nonparallel to the extending direction of the end portion of the object, and an inspection target area in the peculiar light scattering image.

FIG. 14A is a diagram schematically illustrating an example of a setting range of an inspection target area in a case where an inspection is performed by using pattern lights having a modulation direction that is parallel to the extending direction of an upper end or a lower end, in regard to an object having an outer shape (end portion) of a parallelogram.

FIG. 14B is a diagram schematically illustrating an example of a setting range of an inspection target area in a case where an inspection is performed by using pattern lights having a modulation direction that is parallel to the extending direction of a left end or a right end, in regard to an object having an outer shape (end portion) of a parallelogram.

FIG. 15 is a flowchart illustrating a subroutine of step S11 illustrated in FIG. 7, in regard to a process by an optical inspection program that is executed by using an optical inspection apparatus according to a second embodiment.

FIG. 16 is a schematic diagram illustrating an object that can be a target of an inspection by an optical inspection apparatus according to a modification of the second modification, pattern lights used at a time of inspecting the object, a modulation direction of the pattern light, and an inspection target range.

### DETAILED DESCRIPTION

Hereinafter, embodiments are described with reference to the accompanying drawings. The drawings are schematic or conceptual ones, and the relationship between the thickness and width of each of parts illustrated in the drawings, and the ratio in size between the parts, and the like, do not necessarily agree with the actual ones. Even in a case where identical parts are depicted, the parts may be depicted with different dimensions and ratios between the drawings. In the present specification and drawings, the elements similar to those described in connection with preceding drawings are denoted by like reference signs, and a detailed description thereof is omitted unless where necessary.

In addition, the term “light” used in the description below is a kind of electromagnetic wave, and includes gamma rays, X-rays, ultraviolet, visible light, infrared, radio waves, and the like. Hereinafter, the description is given on the assumption that the light is visible light. The visible light belongs to a wavelength region of, for example, 400 nm to 750 nm. On the other hand, in a case where the term “light” is mentioned in the description below, the term “light” can be replaced with gamma rays, X-rays, ultraviolet, visible light, infrared, radio waves, or the like.

It is an object of an embodiment to provide an optical inspection apparatus, an optical inspection method, and a non-transitory storage medium storing an optical inspection program, which is configured to prevent erroneous detection of a peculiar area such as a defect.

According to the embodiment, an optical inspection apparatus includes a controller. The controller is configured to: project first modulation pattern lights having an intensity modulation pattern, in which an extending direction of an end portion of an object and a modulation direction are substantially parallel, onto the object; acquire a first image group by imaging the object onto which the first modulation pattern lights are projected; and generate, by a peculiar scattering extraction process, a first peculiar light scattering image that is able to include an image of a peculiar area that is located at the end portion of the object or in an area inside the end portion, is extracted based on the first image group, and causes peculiar light scattering due to the first modulation pattern lights.

### First Embodiment

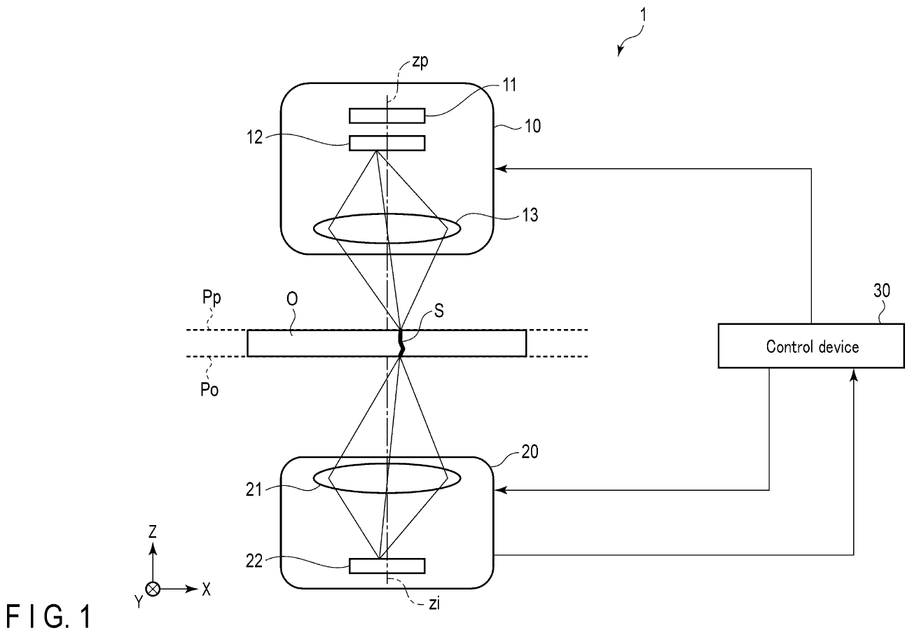

A first embodiment is described with reference to FIG. 1 to FIG. 9. FIG. 1 is a diagram illustrating a configuration of an optical inspection apparatus 1 that is an example according to the first embodiment. The optical inspection apparatus 1 of the first embodiment includes a projector 10, an imaging device 20, and a control device 30.

The projector 10 projects modulation pattern light (hereinafter referred to mainly as “pattern light”) having a spatial intensity modulation pattern onto an object O. The pattern light in the present embodiment is light with cyclically changing lightness and darkness on the object O. Here, the cyclical change of lightness and darkness corresponds to such a change of intensity that an area with high light intensity and an area with low light intensity are cyclically positioned. However, “cyclical” does not necessarily mean only a pattern repeating at regular intervals. Specifically, the cycle may vary. In other words, “cyclical” corresponds to repetitive positioning of an area with high intensity and an area with low intensity. Hereinafter, for the purpose of simple description, “cyclical” refers to a pattern with fixed cycles, unless otherwise specified. In addition, as will be described later in detail, in the first embodiment, the projector 10 is configured to project pattern lights in two modulation modes corresponding to two different spatial intensity modulation patterns. In the present specification, black-and-white projection and color projection are described as projection.

Here, it is assumed that the object O has transmissivity to, for example, visible light, and is formed of a uniform scattering medium. The material, shape and thickness of the object O are not particularly limited. Hereinafter, the description is given on the assumption that the object O in the present embodiment is a plate having a thickness of several millimeters and having light transmissivity. In addition, the description is given on the assumption that, of two surfaces of the plate-shaped object O, which are opposed in the thickness direction of the object O, one surface on which pattern light is projected is defined as a back side, and the other surface that is photographed is defined as a front side. In the example of FIG. 1, the pattern light is projected from the back side of the object O onto the back-side surface, passes through the object O while being scattered within the object O, reaches the front-side surface of the object O, and emanates from the object O. An image of the object O is imaged with the light emanating from the object O. That surface of the object O, onto which pattern light is projected, is generally referred to as a projection surface Pp, and that surface of the object O, which is imaged, is referred to as an object surface Po. Specifically, in the example of FIG. 1, the projection surface Pp is the back-side surface of the object O, and the object surface Po is the front-side surface of the object O.

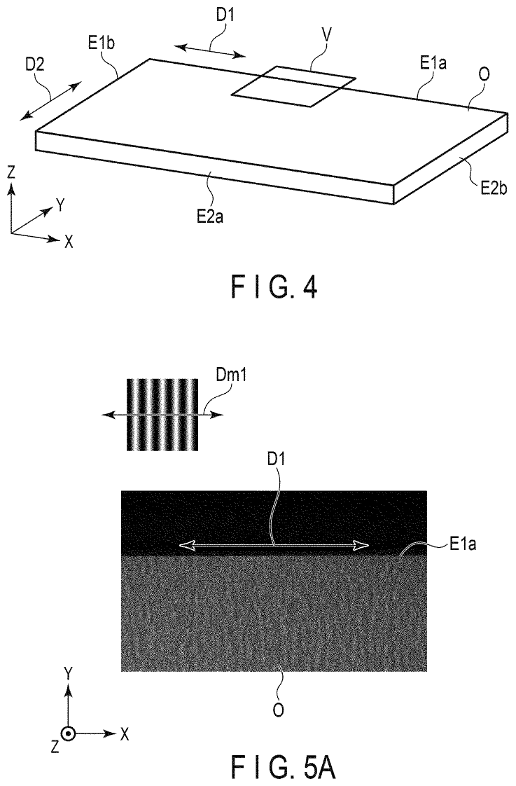

In the present embodiment, as illustrated in FIG. 1, an XYZ orthogonal coordinate system is set for the optical inspection apparatus 1. It is assumed that the object O is a substantially rectangular plate, and the projection surface Pp and object surface Po are disposed to be parallel or substantially parallel to a plane defined by an X axis and a Y axis. In addition, it is assumed that the projection surface Pp and object surface Po of the object O are perpendicular to a Z axis. Besides, it is assumed that a pair of end portions (end edges) E1a and E2a (see FIG. 4) of the object O are parallel to the X axis, and the other pair of end portions (end edges) E1b and E2b (see FIG. 4) of the object O are parallel to the Y axis. Here, the end portions E1a and E2a that are parallel to the X axis are mainly described.

In addition, in the first embodiment, there is a case where the object O includes a peculiar area S. The peculiar area S is a local area in the inside or on the surface of the object O, the peculiar area S being formed of a peculiar medium or in a peculiar shape. The peculiar medium or peculiar shape is, for example, a foreign matter or bubble mixed in the object, a crack or breakage occurring in the object O, an area of peculiar density occurring due to stress-strain of the object O, a minute recess-and-projection shape on the surface of the object O, or a surface with surface roughness of the object O, which is different from the surface roughness of a surrounding surface. However, the peculiar medium or peculiar shape is not limited to these examples.

The projector 10 includes a light source 11, a spatial modulator 12 and a projection optical element 13.

The light source 11 emits light. The light source 11 can be a freely chosen light source, such as a laser light source, an LD (Laser Diode) light source, an LED (Light Emitting Diode) light source, a filament light source, a halogen lamp, or a xenon lamp. For example, in the first embodiment, the description is given on the assumption that the light source 11 is a white LED light source. It is assumed that a wavelength spectrum of white light has a significant intensity in a wavelength range of 450 nm to 750 nm. Here, the light source 11 may be provided separately from the projector 10.

The spatial modulator 12 includes a modulation surface. The modulation surface is composed of an aggregate of modulation pixels. The modulation surface varies the characteristics of light independently in regard to each of the modulation pixels. The characteristics of light include, for example, an intensity, a polarization direction, and a wavelength spectrum. The modulation surface may be, for example, a DMD (Digital Micromirror Device), an LCD (Liquid Crystal Display) panel, or an LCOS (Liquid Crystal on Silicon) panel. The shape of the modulation surface may be any shape. For example, the shape of the modulation surface may be an area shape or a line shape.

The projection optical element 13 includes a projection optical axis zp, and forms an image of pattern light, which is acquired by spatial modulation by the spatial modulator 12, on the object O along the projection optical axis zp. Thereby, a projection image corresponding to the modulation surface is formed on the object O. The projection optical element 13 is, for example, a lens. However, the projection optical element 13 may be any element that can form an image of light, which is emitted from an object point in a space, at an image point. In the case of an optical system defined by the projection optical element 13, the object point is a point on the modulation surface of the spatial modulator 12, and the image point is a point on the projection surface Pp of the object O.

The imaging device 20 includes an imaging optical element 21 and an image sensor 22. The imaging device 20 images the object O with light emanating from the object surface Po of the object O, and acquires an image of the object O.

The imaging optical element 21 includes an imaging optical axis zi, and forms an image of light, which emanates from the object O, on the image sensor 22. The imaging optical element 21 is, for example, a lens. The imaging optical element 21 may be any element that can form an image of light, which is emitted from an object point in a space, at an image point. In the case of an optical system defined by the imaging optical element 21, the object point is a point on the object surface Po of the object O, and the image point is a point on a pixel surface of the image sensor 22.

The image sensor 22 includes a pixel surface. The pixel surface is composed of an aggregate of imaging pixels by photoelectric conversion elements. Each imaging pixel converts incident light into a pixel signal as an electric signal. An aggregate of pixel values based on pixel signals is an image. The image sensor 22 is, for example, a CMOS (Complementary Metal Oxide Semiconductor) image sensor. The image sensor 22 may be any sensor that can acquire an image. In addition, the shape of the pixel surface may be any shape. The shape of the pixel surface may be an area shape or a line shape.

The control device 30 is a computer that executes control of the optical inspection apparatus 1. The control device 30 controls start/stop of irradiation of pattern light from the projector 10, and controls switching of a modulation mode. In addition, the control device 30 generates, by a peculiar scattering extraction process, a first peculiar light scattering image as an inspection image, from a plurality of images (first image group) acquired from the imaging device 20.

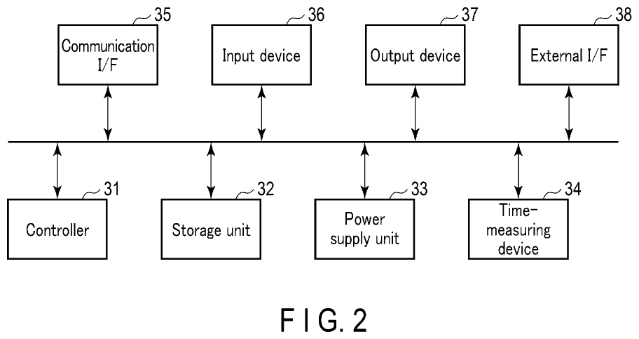

FIG. 2 is a diagram illustrating an example of a hardware configuration of the control device 30. As illustrated in FIG. 2, the control device 30 includes a computer in which a controller (processor) 31, a storage unit (non-transitory storage medium) 32, a power supply unit 33, a time-measuring device 34, a communication interface (I/F) 35, an input unit 36, an output device 37, and an external interface (I/F) 38 are electrically connected. Here, the control device 30 may include an element other than the elements illustrated in FIG. 2, or may not include some of the elements illustrated in FIG. 2. For example, the control device 30 may not include the time-measuring device 34.

The controller 31 includes a processor such as a CPU (Central Processing Unit), and a memory such as a RAM (Random Access Memory) and/or a ROM (Read Only Memory), and controls the structural elements of the control device 30. The controller 31 can call out an execution program that is stored in the storage unit 32, and can execute a process.

The storage unit 32 is a medium that stores information such as a program, in such a manner that a computer or the like can read the information. The storage unit 32 can be, for example, an auxiliary storage device such as a hard disk drive or a solid state drive. Further, the storage unit 32 may include a drive. The drive is a device for reading data stored in another auxiliary storage device and recording medium, and the like, and includes, for example, a semiconductor memory drive (flash memory drive), a CD (Compact Disk) drive, and a DVD (Digital Versatile Disk) drive. The kind of drive may be selected as appropriate, in accordance with the kind of storage medium.

The power supply unit 33 supplies electric power to the respective elements of the control device 30. The power supply unit 33 can include, for example, a secondary battery or an AC power supply.

The time-measuring device 34 is a device that measures time. For example, the time-measuring device 34 may be a clock including a calendar, and delivers information of the present year/month, and/or date/hour, to the controller 31. The time-measuring device 34 may be utilized in a case of adding an inspection date/hour, or the like.

The communication interface 35 is, for example, a short-range wireless communication (for example, Bluetooth (trademark)) module, a wired LAN (Local Area Network) module, or a wireless LAN module, and is an interface for executing wired or wireless communication via a network. The communication via the network may be wireless communication or wired communication. Note that the network may be an internetwork including the internet, or another kind of network such as an intracompany LAN. In addition, the communication interface 35 may execute one-to-one communication using a USB (Universal Serial Bus) cable or the like. Furthermore, the communication interface 35 may include a micro-USB connector. The communication interface 35 is an interface for connection to an external device such as various communication devices. The communication interface 35 is controlled by the controller 31, and sends information of various kinds to an external device via a network or the like. The information of various kinds is, for example, an inspection image relating to the object O.

The input unit 36 is a device that accepts an input, and can be, for example, a touch panel, a physical button, a mouse, and a keyboard. In addition, the output device 37 is a device that executes an output, and is, for example, a display or the like that outputs information by display or the like.

The external interface 38 is a component for mediating between the main body of the optical inspection apparatus 1 and an external device. The external device may be, for example, a printer, a memory, and a communication device.

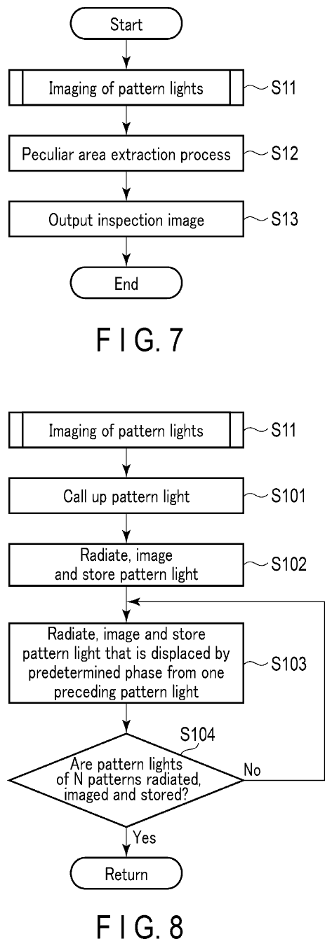

The controller 31 causes a processor to execute a program or the like stored in the storage unit 32, thereby executing a process of exhibiting various functions. It is also preferable that the control program of the controller 31 is put on an appropriate server or cloud, instead of being stored in the storage unit 32 of the controller 31. In this case, the control program is executed while communicating with, for example, the processor included in the optical inspection apparatus 1 via the communication interface 35. The controller 31 according to the present embodiment may be disposed near the projector 10 or imaging device 20, or may be provided on a server or a cloud of a system of various kinds of inspection sites that are remote from the projector 10 or imaging device 20. It is thus preferable that an optical inspection program is not stored in the storage unit 32 but is put on the server or cloud, and the program is executed while communicating with, for example, the processor included in the optical inspection apparatus 1 via the communication interface 35. Accordingly, the controller (processor) 31 can execute an optical inspection program (optical inspection algorithm) (see FIG. 7 to FIG. 9) stored by the storage unit (non-transitory storage medium) 32 to be described later.

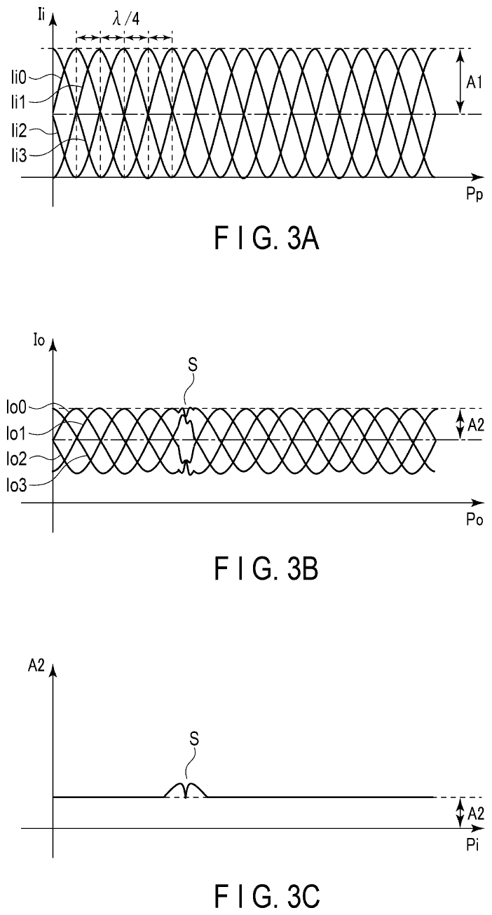

Next, a description is given of an optical inspection method using the optical inspection apparatus 1 according to the present embodiment. FIG. 3A to FIG. 3C are diagrams illustrating the optical inspection method of the first embodiment. In the optical inspection method of the first embodiment, pattern lights having a spatial intensity modulation pattern are projected onto an object. Then, the object O is imaged with the lights passing through the object, and an image is acquired based on pixel signals acquired by the photography. The pattern light is formed of, for example, white light.

In the first embodiment, a plurality of pattern lights having the same modulation direction are radiated onto the object O from the projector 10 at time intervals or with the passing of time. Thereby, a plurality of images corresponding to the respective pattern lights are acquired in the imaging device 20. Based on these images, information relating to the peculiar area S of the object O is acquired by the control device 30.

Light incident on the peculiar area S exhibits a different scattering characteristic from light incident on a uniform medium around the peculiar area S. Specifically, the scattering distribution of light is different between the uniform medium and the peculiar area. In other words, the peculiar area S is a local area that exhibits a different light scattering characteristic from a light scattering characteristic of the uniform medium. The peculiar area S may be any local area that causes peculiar light scattering. For example, peculiar light scattering occurs at a crack, a breakage or stain on the surface, or foreign matter in the object O. Accordingly, an inspection of presence/absence of a crack in the object O is performed by detecting the presence/absence of the peculiar area S of the object O.

FIG. 3A illustrates pattern lights (one set of first modulation pattern lights) that are projected onto the projection surface Pp of the object O. An abscissa axis of FIG. 3A indicates a position of the projection surface Pp of the object O, for example, on one line segment on the drawing sheet of FIG. 1. An ordinate of FIG. 3A indicates an intensity Ii of the pattern light on the projection surface Pp. The intensity modulation pattern is a cyclic modulation pattern. As illustrated in FIG. 3A, one example of the pattern light is a trigonometric function wave with a modulation amplitude A1, and a plurality of pattern lights that are displaced by equal phase distances are overlappingly illustrated. One example is illustrated in which four pattern lights Ii0, Ii1, Ii2 and Ii3 of trigonometric function waves having initial phases of 0 degree, 90 degrees, 180 degrees and 270 degrees are overlapped to be used as the pattern lights. In the present embodiment, by way of example, the pattern light is pattern light with lightness and darkness of a trigonometric wave, but may be pattern light of a rectangular wave that varies in a rectangular wave shape. In addition, the number of pattern lights may be N, which satisfies initial phase 360 degrees (°)/N, and N may be an integer of three or more. Here, the first modulation amplitude A1 is spatially uniform. However, the first modulation amplitude A1 is not limited to this.

Note that the pattern light (pattern light of a basic modulation mode) Ii0 and the pattern light (pattern light of a reversed modulation mode) Ii2 in FIG. 3A are reversed in regard to lightness and darkness on the projection surface Pp. Similarly, the pattern light Ii1 and the pattern light Ii3 in FIG. 3A are reversed in regard to lightness and darkness on the projection surface Pp.

The pattern light projected onto the object O passes through the object O while being scattered by the object O. In addition, the pattern light reaches the front side of the object O. In this manner, by the object O being imaged with the light reaching the front-side surface of the object O, the imaging device 20 acquires an image.

In the case where the object O is the uniform medium, the lightness and darkness of the light reaching the front-side surface of the object O cyclically changes like the pattern light projected onto the object O. In other words, in the case where the object O is the uniform medium, the intensity of the pattern light projected onto the projection surface Pp and the intensity of the light reaching the object surface Po have a positive correlation. Thereby, an intensity Io of an area of the object surface Po, which is opposed to an area with a high intensity Ii on the projection surface Pp, becomes greater than an intensity Io of an area of the object surface Po, which is opposed to an area with a low intensity Ii on the projection surface Pp.

FIG. 3B illustrates an example of light on the object surface Po, which corresponds to the projection of the pattern lights of FIG. 3A. An abscissa axis of FIG. 3B indicates a position on one light segment of the object surface Po, which corresponds to, for example, one line segment on the drawing sheet (XZ plane) of FIG. 1 of the projection surface Pp of the object O. An ordinate of FIG. 3B indicates an intensity Io of pattern light on the object surface Po.

As illustrated in FIG. 3B, with the light passing through the object O while being scattered, a modulation amplitude A2 becomes lower than the amplitude A1. In short, amplitude A2<A1.

In addition, due to the influence of a crack or a surface flaw, the pattern light passing through the peculiar area S is transmitted to the object surface Po with the scattering state being locally varied. The pattern light appearing on the object surface Po through the peculiar area S has a shape different from the shape of the surrounding trigonometric function wave.

Next, a description is given of an arithmetic operation (peculiar scattering extraction process) for demodulating the amplitude A2 from four pattern images (first image group) Io0, Io1, Io2 and Io3 imaged by the imaging device 20.

In the above description, the number of pattern lights is assumed to be four. Here, a computation method is generally described with N patterns (N is an integer of three of more). Each of the N patterns has a cyclic structure with a phase different by T/N in relation to a cycle T. Assuming that n is an integer, the phase (radian) of each pattern light is α=2 nn/N. Here, if attention is paid to a certain point (pixel point) x in a certain space, a pixel value Ion(x) of a pattern image at this point can be considered such that pixel values of N points in the n direction are sampled at equal intervals of 1/N. Specifically, a function having n as a variable, like Ion(x)=I(n), can be considered. By performing discrete Fourier transform for the variable n, and assuming that the cycle is 1, the amplitude A2 in the n direction at the point x and an initial phase φ can be computed.

$$A 2 \cdot {e}^{i ϕ} = ℱ ( I ( n ) ) {\vert}_{T = 1} = \frac{2}{N} {\sum }_{n = 0}^{N - 1} I ( n ) exp ( - i 2 π \frac{n}{N} \cdot 1 ) \qquad ( 1 )$$

The magnitude of A2·^{iφ} computed in equation (1) becomes the amplitude A2. Specifically, the amplitude A2 is acquired as equation (2).

$$A 2 = \vert A 2 \cdot {e}^{i ϕ} \vert \qquad ( 2 )$$

An amplitude image is generated by performing this arithmetic operation for each of the pixel values of the pattern images (first image group) Io0, Io1, Io2 and Io3. A concrete example in a case of N=4 is described. By substituting N=4 for equations (1) and (2), the modulation amplitude A2 can be expressed as equation (3).

$$A 2 = \frac{1}{2} \sqrt{{( {I}_{o} 0 - {I}_{o} 2 )}^{2} + {( {I}_{o} 1 - {I}_{o} 3 )}^{2}} \qquad ( 3 )$$

Specifically, the peculiar scattering extraction process of the controller 31 is a process of computing the modulation amplitude A2 at each pixel point. The pattern images Io0, Io1, Io2 and Io3 that are the first image group are images that become the basis of the peculiar scattering extraction process of the controller 31.

FIG. 3C illustrates an example of an amplitude image generated by using an image photographed with the light on the object surface Po of FIG. 3B corresponding to the projection of pattern lights, with use of equations (1) and (2). An abscissa axis of FIG. 3C indicates a position of the photographed image corresponding to one line segment of the object surface Po of the object O. An ordinate of FIG. 3C indicates the modulation amplitude A2 corresponding to an imaging surface Pi.

As illustrated in FIG. 3C, in an area with a uniform scattering characteristic of the object O, the modulation amplitude A2 of the area can be acquired, while the vicinity of the peculiar area S has a greater amplitude than the surrounding area thereof. Specifically, the area with the uniform scattering characteristic and the peculiar area S can be distinguished by comparing the magnitudes of the modulation amplitude A2.

Here, although the modulation amplitude A2 is computed by using equations (1) and (2), the modulation amplitude itself may not be used, and, for example, use may be made of an amplitude to which an offset value is added or subtracted, an amplitude multiplied by a constant value, an amplitude raised to a power, or a combination thereof. Specifically, such an arithmetic operation that a large/small relationship of amplitude is not lost may be used, and such an arithmetic operation is performed subsequently, and a generated image is referred to as a peculiar light scattering image (first peculiar light scattering image).

Next, the modulation direction of pattern lights radiated onto the object O from the projector 10 is described. In particular, it was found that in a case of inspecting end portions of E1a, E2a, E1b and E2b and/or vicinities thereof (vicinities of ends) of an inspection target, the modulation direction greatly affects the extraction accuracy of the peculiar area S.

In the present embodiment, it is assumed that a modulation direction Dm1 of pattern lights (first modulation pattern lights) for the controller 31 to generate a scattering image by the projector 10 is substantially parallel to an extending direction D1 of end portions E1a, E2a of the object O that is the inspection target.

FIG. 4 illustrates an entire image of the object O. The object O illustrated in FIG. 4 includes four end portions E1a, E2a, E1b and E2b. Of these end portions, two end portions E1a and E2a are formed parallel or substantially parallel, and the other two end portions E1b and E2b are formed parallel or substantially parallel. In addition, in the present embodiment, the end portions E1a, E2a and the end portions E1b, E2b are perpendicular to each other. An extending direction of the end portions E1a, E2a is defined as D1, and an extending direction of the end portions E1b, E2b extend is defined as D2.

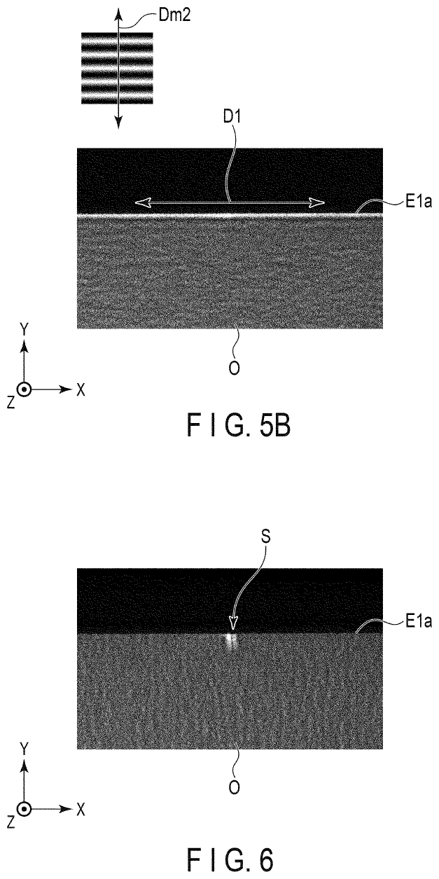

FIG. 5A illustrates a scattering image (first peculiar light scattering image) in a case where the modulation direction Dm1 of pattern lights at a position including the end portion E1a indicated by reference sign V in FIG. 4 is substantially parallel to the extending direction D1 of the end portion E1a of the object O. The pattern lights for acquiring such a scattering image, for example, as illustrated in FIG. 3A, are successively radiated on the object O by being displaced by an equal phase distance, such as λ/4, in the X axis direction.

In addition, FIG. 5B illustrates a modulation amplitude image (second peculiar light scattering image) generated by computing an amplitude in a case where a modulation direction Dm2 of pattern lights at the position indicated by reference sign V in FIG. 4 is a direction D2 that is substantially perpendicular to the extending direction D1 of the end portion E1a of the object O. The pattern lights (second modulation pattern lights) for acquiring such a peculiar light scattering image, for example, the pattern lights as illustrated in FIG. 3A, are successively radiated on the object O by being displaced by an equal phase distance, such as λ/4, not in the X axis direction, but in the Y axis direction.

The end portions E1a, E2a, E1b, E2b of the object O are an interface between the object O and an outside, and are, in general, an interface between the object O and air. It can be said that the scattering characteristics in the inside of the object O are discontinuous at the end portions E1a, E2a, E1b, E2b of the object O. Thus, at the end portions E1a, E2a, E1b, E2b of the object O, peculiar scattering occurs similarly as at the peculiar area S. As regards the peculiar scattering at the end portions E1a, E2a, E1b, E2b of the object O, like the peculiar area S due to a crack or foreign matter, the intensity in the scattering image thereof increases. The increase in the intensity in the scattering image varies in its magnitude in accordance with the relationship between the modulation direction Dm1, Dm2 of the pattern lights and the extending direction of the end portions E1a, E2a, E1b, E2b of the object O.

As illustrated in FIG. 5A, if the extending direction of the end portion E1a of the object O is substantially parallel to the modulation direction Dm1 of the pattern lights, there occurs no substantial increase of the modulation amplitude at the end portion E1a of the object O. However, in a case where the extending direction D1 of the end portion E1a of the object O and the modulation direction Dm2 of the pattern light are not parallel (nonparallel) with respect to the end portion E1a of the object O, and, as illustrated in FIG. 5B, the modulation direction Dm2 is the direction D2 perpendicular to the extending direction D1 of the end portion E1a of the object O, there occurs an increase of the modulation amplitude due to peculiar scattering near the end portion E1a of the object O. It is difficult to distinguish such an increase of the modulation amplitude due to peculiar scattering near the end portion E1a of the object O from that at the peculiar area S to be extracted, such as a crack of the object O.

In the present embodiment, by using the peculiar light scattering image generated by using the pattern lights having the modulation direction Dm1 parallel to the extending direction D1 of the end portion E1a of the object O, the peculiar area S near the end portion E1a of the object O is extracted. By using the pattern light having the modulation direction Dm1 parallel to the extending direction D1 of the end portion E1a of the object O, the extraction accuracy of the peculiar area S can be enhanced, without erroneously extracting the increase of the modulation amplitude on the scattering image occurring due to the end portion E1a of the object O, or overlooking the peculiar area S existing in such a manner as to overlap the area of the increase of the modulation amplitude.

FIG. 6 illustrates an example of a peculiar light scattering image in a case where the peculiar area S is actually present at the end portion E1a of the object O and the vicinity thereof. This peculiar light scattering image was generated by using the pattern lights (see FIG. 5A) having the modulation direction Dm1 substantially parallel to the extending direction D1 of the end portion E1a of the object O. While a desired scattering area of the object O indicating the surface of the object O appears relatively bright, there occurs no bright part due to peculiar scattering due to the end portion E1a of the object O. Thus, by generating the peculiar light scattering image by using the pattern lights having the modulation direction Dm1 parallel to the extending direction D1 of the end portion E1a of the object O, the optical inspection apparatus 1 can extract the peculiar area S with high accuracy in the area inside the end portion E1a of the object O.

FIG. 7 and FIG. 8 are flowcharts illustrating an optical inspection method that is executed by using the optical inspection apparatus 1 according to the first embodiment. The operation illustrated in FIG. 7 and FIG. 8 can be controlled by the controller 31 of the control device 30.

In step S11, the controller 31 causes the projector 10 to successively project the pattern lights (see FIG. 5A), which have the modulation direction Dm1 substantially parallel to the extending direction D1 of the end portion E1a of the object O, onto the object O, while modulating the pattern lights, and causes the imaging device 20 to image the pattern lights passing through the object O. In addition, images acquired by the photography by the imaging device 20 are stored in a predetermined storage area of the storage unit 32 of the control device 30.

In the photography of the pattern lights in step S11, as illustrated in FIG. 8, the controller 31 first calls up projection patterns having a certain modulation direction Dm1, which are stored, for example, in a predetermined storage area of the storage unit 32, in order to successively project the pattern lights (first modulation pattern lights) onto the object O (step S101). Note that a plurality of projection patterns Ii0, Ii1, Ii2 and Ii3 having the identical modulation direction Dm1 and having different phases may be called up at a time from the predetermined storage area of the storage unit 32, or the projection patterns Ii0, Ii1, Ii2 and Ii3 may be called up successively.

One of the pattern lights (for example, pattern light Ii0 in FIG. 3A) having the modulation direction Dm1 substantially parallel to the extending direction D1 of the end portion E1a of the object O is projected onto the object O from the projector 10, and the controller 31 causes the imaging device 20 to image the pattern light passing through the object O, and causes the storage unit 32 to store the image thereof (pattern image Io0) (step S102). The image (pattern image Io0) becomes one image of the first image group.

Pattern light (for example, pattern light Ii1 in FIG. 3A), which is displaced by a predetermined phase from one preceding radiated pattern light (for example, pattern light Ii0 in FIG. 3A), is projected onto the object O, and the controller 31 causes the imaging device 20 to image the pattern light passing through the object O, and causes the storage unit 32 to store the image thereof (pattern image Io1) (step S103). The image (pattern image Io1) becomes one image of the first image group.

In addition, the controller 31 determines whether the pattern lights of predetermined N patterns (N is an integer of three or more; N is assumed to be 4 in this example) were projected onto the object O, the imaging device 20 was caused to image the pattern lights of the predetermined N patterns, and the storage unit 32 was caused to store the images thereof (step S104). If the pattern lights of the predetermined N patterns (four patterns) are not projected onto the object O (step S104-No), pattern light (for example, pattern light Ii2 in FIG. 3A), which is displaced by a predetermined phase from one preceding radiated pattern light (for example, pattern light Ii1 in FIG. 3A), is projected onto the object O, and the controller 31 causes the imaging device 20 to image the pattern light passing through the object O, and causes the storage unit 32 to store the image thereof (pattern image Io2). The image (pattern image Io2) becomes one image of the first image group.

Pattern light (for example, pattern light Ii3 in FIG. 3A), which is displaced by a predetermined phase from one preceding radiated pattern light (for example, pattern light Ii2 in FIG. 3A), is projected onto the object O, and the controller 31 causes the imaging device 20 to image the pattern light passing through the object O, and causes the storage unit 32 to store the image thereof (pattern image Io3). The image (pattern image Io3) becomes one image of the first image group. Specifically, the projector 10 projects the first modulation pattern lights onto the object O, and the imaging device 20 acquires the first image group.

If the pattern lights of the predetermined N patterns are projected onto the object O, the imaging device 20 is caused to image the pattern lights, and the storage unit 32 is caused to store the images thereof (step S104-Yes), the process illustrated in FIG. 8 is terminated, that is, the process of step S11 by the controller 31 of the optical inspection apparatus 1 as illustrated in FIG. 7 is terminated, and the controller 31 subsequently executes a process of step S12.

In step S12, as a peculiar area extraction process, the controller 31 generates a peculiar light scattering image (first peculiar light scattering image) by using N (here, N=4) photographed images (pattern images of the first image group) Io0, Io1, Io2 and Io3 (see FIG. 5A and FIG. 6). By the generated peculiar light scattering image that is an inspection image, the peculiar area S is emphasized, compared to the other area of the uniform medium including the end portions E1a, E2a of the object O (see, for example, FIG. 6). Note that, as illustrated in FIG. 5A, needless to say, there is a case where no peculiar area S appears on the object O.

In step 513, the controller 31 outputs the peculiar light scattering image (first peculiar light scattering image) as the inspection image relating to the object O. For example, the controller 31 displays the inspection image on the display of the output device 37. Alternatively, the controller 31 transmits the inspection image to an analysis device (image processing apparatus) that is not illustrated, by using the communication interface 35. In this manner, the controller 31 of the optical inspection apparatus 1 terminates the serial process (optical inspection method) relating to the optical inspection, which is illustrated in FIG. 7 and FIG. 8.

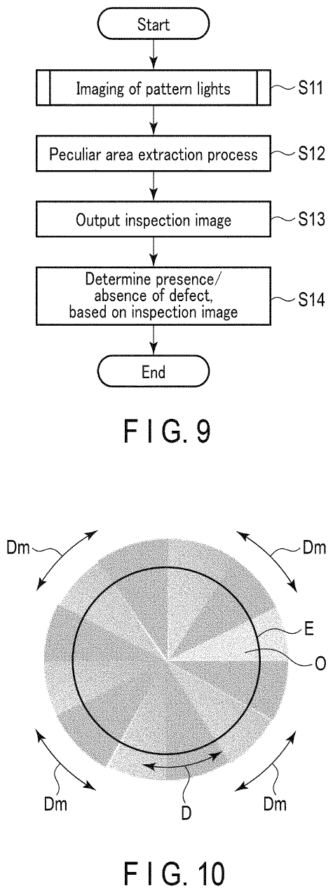

Note that the analysis device analyzes the presence/absence of the peculiar area S as a defect such as a crack, by comparing each pixel of the inspection image with a prestored threshold representing the peculiar area S. Such analysis may be performed by the controller 31 (see step S14 of FIG. 9). Specifically, the controller 31 of the optical inspection apparatus 1 according to the present embodiment can determine the presence/absence of the peculiar area S such as a defect, based on the inspection image (peculiar light scattering image) of the object O.

As has been described above, in the present embodiment, the pattern lights Ii0, Ii1, Ii2 and Ii3 having the modulation direction Dm1 substantially parallel to the extending direction D1 of the end portions E1a, E2a of the object O are projected onto the object O, and the controller 31 generates the peculiar light scattering image from the images (first image group) Io0, Io1, Io2 and Io3 acquired by imaging the object O. In the peculiar light scattering image, there occurs no peculiar bright part due to the end portions E1a, E2a of the object O, and the peculiar area S can be emphasized. Accordingly, the optical inspection apparatus 1 according to the present embodiment can acquire information relating to the peculiar area S of the object O, from the peculiar light scattering image.

The controller 31 of the optical inspection apparatus 1 according to the present embodiment causes first modulation pattern lights having an intensity modulation pattern, in which the extending direction D1 of the end portions E1a, E2a of the object O and the modulation direction Dm1 are substantially parallel, to be projected onto the object O, and causes a first image group to be acquired by imaging the object O onto which the first modulation pattern lights are projected. In addition, the controller 31 generates, by the peculiar scattering extraction process, the first peculiar light scattering image that can include an image of the peculiar area S that is located at the end portions E1a, E2a of the object O or in the area inside the end portions E1a, E2a, is extracted based on the first image group, and causes peculiar light scattering due to the first modulation pattern lights.

The optical inspection method according to the present embodiment includes projecting first modulation pattern lights having an intensity modulation pattern, in which the extending direction D1 of the end portions E1a, E2a of the object O and the modulation direction Dm1 are substantially parallel, onto the object O, and acquiring a first image group by imaging the object O onto which the first modulation pattern lights are projected. In addition, the optical inspection method includes generating, by the peculiar scattering extraction process, the first peculiar light scattering image that can include an image of the peculiar area S that is located at the end portions E1a, E2a of the object O or in the area inside the end portions E1a, E2a, is extracted based on the first image group, and causes peculiar light scattering due to the first modulation pattern lights.

The optical inspection program (algorithm) according to the present embodiment causes a computer to execute projecting first modulation pattern lights having an intensity modulation pattern, in which the extending direction D1 of the end portions E1a, E2a of the object O and the modulation direction Dm1 are substantially parallel, onto the object O, acquiring a first image group by imaging the object O onto which the first modulation pattern lights are projected, and generating, by the peculiar scattering extraction process, the first peculiar light scattering image that can include an image of the peculiar area S that is located at the end portions E1a, E2a of the object O or in the area inside the end portions E1a, E2a, is extracted based on the first image group, and causes peculiar light scattering due to the first modulation pattern lights.

According to the present embodiment, there can be provided the optical inspection apparatus 1, optical inspection method and optical inspection program, which can prevent erroneous detection of a peculiar area S, such as a defect, of the object O near the end portions E1a, E2a of the object O, by using the pattern lights having the intensity modulation pattern in which the extending direction D1 of the end portions E1a, E2a of the object O and the modulation direction Dm1 are substantially parallel.

In addition, according to the present embodiment, the controller 31 detects the peculiar area S of the object O by using the first peculiar light scattering image. Thus, there is provided the optical inspection apparatus 1 that can prevent erroneous detection of a peculiar area S, such as a defect, of the object O near the end portions E1a, E2a of the object O.

In the present embodiment, the example was described in which the projection surface Pp and object surface Po of the object O are parallel or substantially parallel (see FIG. 1 and FIG. 4). Although not illustrated, a case is considered in which the projection surface Pp and object surface Po of the object O are nonparallel. For example, in a thick part of the object O, compared to a thin part of the object O, the pattern light less easily passes therethrough, and the amplitude of the pattern light that is photographed becomes lower. Specifically, the amplitudes Io0, Io1, Io2 and Io3 (see FIG. 3B) of the normal area, which is the base part of the peculiar light scattering image, do not become constant values. However, if a spatial variation ratio of the base part is different from a spatial variation ratio of a bright part due to the peculiar area S such as a defect, the base part and the peculiar area S due to the bright part can be separated by an image process (spatial frequency filter) (see FIG. 3C). Accordingly, for example, even if the back surface of the object O is a curved surface or an inclined surface, it is possible to perform an optical inspection by using the optical inspection apparatus 1 and to prevent erroneous detection of the peculiar area S.

### First Modification

In the first embodiment, the example in which the outer shape of the object O is rectangular.

FIG. 10 is a schematic diagram illustrating a modulation direction Dm of illumination pattern lights in a case where an end portion (outer edge) E of an object O is circular. It is assumed that the object O illustrated in FIG. 10 is a light-transmissive plate having a thickness of about several millimeters.

FIG. 10 illustrates such pattern lights that the modulation direction Dm becomes a circumferential direction, as an example of pattern lights having an intensity pattern in which the direction of the end portion E of the circular object O and the modulation direction Dm are substantially parallel. In this manner, the pattern lights do not need to have a spatially uniform modulation direction Dm, and pattern lights matching with the outer shape (end portion E) of the object O may be used.

Like the case where the object O is rectangular, also in the case of the object O illustrated in FIG. 10, the optical inspection apparatus 1 can execute the optical inspection process according to the flowcharts illustrated in FIG. 7 to FIG. 9. Specifically, according to the present embodiment, even in the case where the end portion E of the object O is not straight, but has a discretionary curved shape, there can be provided the optical inspection apparatus 1, optical inspection method and optical inspection program, which can prevent erroneous detection of a peculiar area S, such as a defect, of the object O near the end portion E of the object O, by using the pattern lights having the intensity modulation pattern in which the extending direction D of the end portion E of the object O and the modulation direction Dm of the pattern lights from the projector 10 are substantially parallel.

### Second Modification

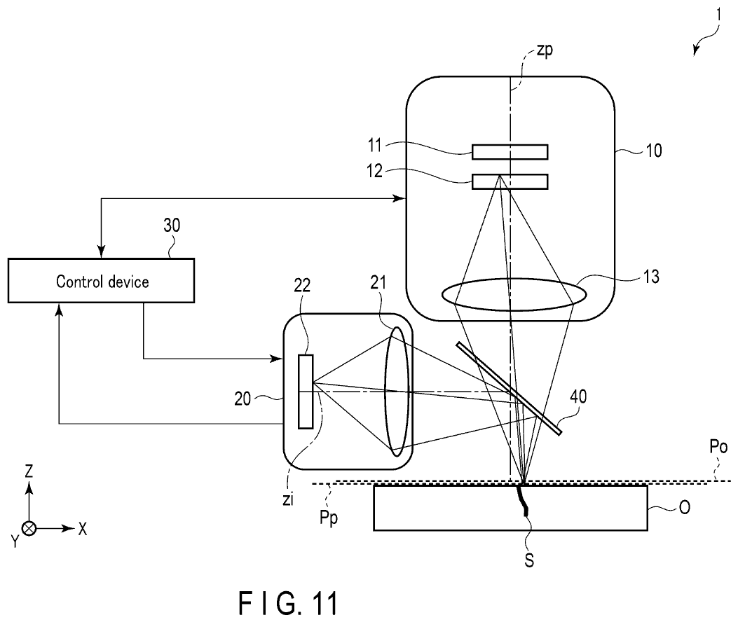

In the first embodiment, the example was described in which the object O is imaged with the pattern light that has passed from the back-side surface of the object O to the front-side surface of the object O. On the other hand, as illustrated in FIG. 11, the object O may be imaged with the pattern light reflected by the back-side surface of the object O. In this case, both the projector 10 and the imaging device 20 are disposed on the back side of the object O. In addition, in this case, both the projection surface Pp and the object surface Po of the object O are the back-side surface of the object O.

As illustrated in FIG. 11, the optical inspection apparatus 1 includes the projector 10, the imaging device 20, the control device 30, and a beam splitter 40. The projector 10 and imaging device 20 are arranged such that the projection optical axis zp of the projector 10 and the imaging optical axis zi of the imaging device 20 cross perpendicularly at the beam splitter 40. However, aside from this, the projector 10 and imaging device 20 may be disposed in such an oblique incidence arrangement that the projection optical axis zp and the imaging optical axis zi cross obliquely.

In the optical inspection apparatus 1 according to the present modification, the object O is imaged, not with the light that has passed from the back-side surface of the object O to the front-side surface, but with the light reflected by the back-side surface of the object O. Specifically, in the optical inspection apparatus 1 according to the present modification, both the projection surface Pp and the object surface Po of the object O are the back-side surface of the object O.

The beam splitter 40 is a non-polarizing splitter or a polarizing splitter. Alternatively, the beam splitter 40 may be a dichroic mirror. In a case where the beam splitter 40 is a polarizing splitter, the beam splitter 40 transmits a regular reflection component from the object O, which is a component of the pattern light projected onto the object O, and reflects only a scattering component, which is scattered and reflected, toward the imaging device 20. The reason is that, in general, polarization varies due to scattering. As described above, the peculiar area S exhibits a peculiar scattering characteristic that is different from the characteristic of the uniform medium around the peculiar area S. On the other hand, the reflective light from the uniform medium generally includes a large regular reflection component. In other words, in the case where the beam splitter 40 is the polarizing splitter, only scattering light from the peculiar area S can easily be extracted. In a case where the beam splitter 40 is a non-polarizing splitter, the projection optical axis zp and the imaging optical axis zi can be made to agree.

### Third Modification

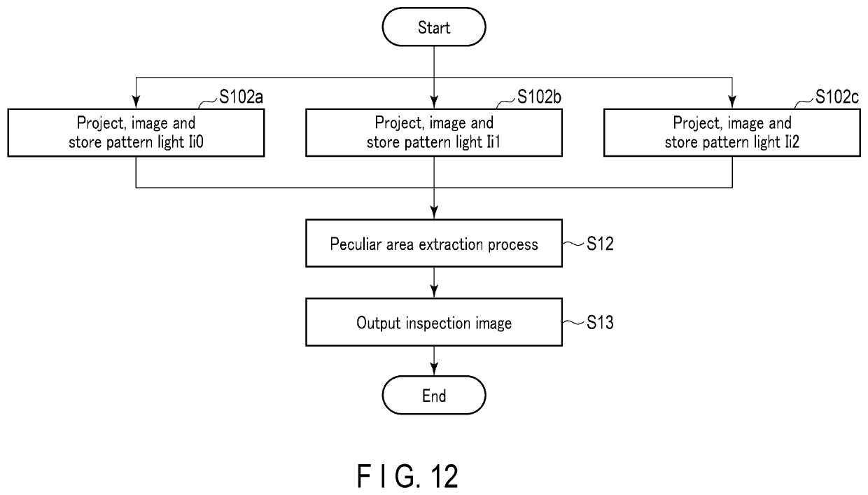

A third modification of the first embodiment is described with reference to FIG. 12.

In the first embodiment, it is assumed that the pattern lights Ii0, Ii1, Ii2 and Ii3 are white light. On the other hand, in the present modification, it is assumed that the pattern lights Ii0, Ii1, Ii2 and Ii3 have different wavelength spectra. For example, the pattern light Ii0 is blue light, and the pattern light Ii1 is read light. The pattern light Ii2 is green light. Note that in the present modification, it is assumed that the three pattern lights Ii0, Ii1 and Ii2 are used, and the pattern light Ii3 is not used.

The blue light is, for example, light having a peak wavelength at a wavelength of 450 nm, the red light is, for example, light having a peak wavelength at a wavelength of 650 nm, and the green light is, for example, light having a peak wavelength at a wavelength of 550 nm. However, the combination of the pattern lights Ii0, Ii1 and Ii2 is not limited to this. Specifically, the combination of the pattern lights Ii0, Ii1 and Ii2 may be any combination of different wavelength spectra.

The image sensor 22 in the present modification is configured to independently receive the pattern lights Ii0, Ii1 and Ii2 having different wavelength spectra. For example, the image sensor 22 includes imaging pixels having spectral sensitivity to red light, blue light and green light. Thereby, images acquired by the image sensor 22 include a color channel corresponding to red light, a color channel corresponding to blue light, and a color channel corresponding to green light. An image including projected light of the pattern light Ii0 can be acquired from the color channel corresponding to red light. Similarly, an image including projected light of the pattern light Ii1 can be acquired from the color channel corresponding to blue light. An image including projected light of the pattern light Ii2 can be acquired from the color channel corresponding to green light.

FIG. 12 is a flowchart illustrating an optical inspection method according to the modification of the first embodiment. The operation of FIG. 12 can be controlled by the controller 31 of the control device 30.

In step S102a, the controller 31 causes the pattern light Ii0 of red light to be projected onto the object O from the projector 10. In addition, in step S102b, the controller 31 causes the pattern light Ii1 of blue light to be projected onto the object O from the projector 10. Further, in step S102c, the controller 31 causes the pattern light Ii2 of green light to be projected onto the object O from the projector 10. In the present modification, the pattern lights Ii0, Ii1 and Ii2 can be projected at the same time or in the same period, and the pattern lights Ii0, Ii1 and Ii2 can be imaged (photography of the first image group) at the same time or in the same period.

The image Io0 of red light corresponding to the pattern light Ii0 of red light, the image Io1 of blue light corresponding to the pattern light Ii1 of blue light, and the image Io2 of green light corresponding to the pattern light Ii2 of green light, which are acquired by the photography of the imaging device 20, are stored in a predetermined storage area of the storage unit 32 of the control device 30. Note that even in a case where the images Io0, Io1 and Io2 are imaged by one-time photography, the images Io0, Io1 and Io2 are processed as separate images Io0, Io1 and Io2 for respective colors by separation of light into spectral components.

In step S12, as a peculiar area extraction process, the controller 31 generates a peculiar light scattering image by computing differences between pixel values (amplitudes) of pixels of the images Io0, Io1 and Io2.

In step S13, the controller 31 outputs an inspection image relating to the object O. Then, the process of FIG. 12 ends. For example, the controller 31 displays the inspection image on the display of the output device 37. Alternatively, the controller 31 transmits the inspection image to an analysis device (not illustrated) by using the communication interface 35. The analysis device analyzes the presence/absence of a defect such as a crack (peculiar area S), for example, by comparing the pixel value of each pixel of the inspection image with a prestored threshold representing the peculiar area S. Such analysis may be executed by the controller 31.

As has been described above, in the present modification, the pattern lights Ii0, Ii1 and Ii2 are made to have spectra of different wavelengths, and the pattern lights Ii0, Ii1 and Ii2 can be radiated on the object O in the same period, and the images Io0, Io1 and Io2 (first image group) corresponding to the pattern lights Ii0, Ii1 and Ii2 can be imaged in the same period. In other words, according to the optical inspection apparatus 1 of the present modification, there is no need to successively radiate and image the pattern lights Ii0, Ii1 and Ii2. Therefore, the inspection time can be shortened by using the pattern lights Ii0, Ii1 and Ii2 according to the present modification.

### Second Embodiment

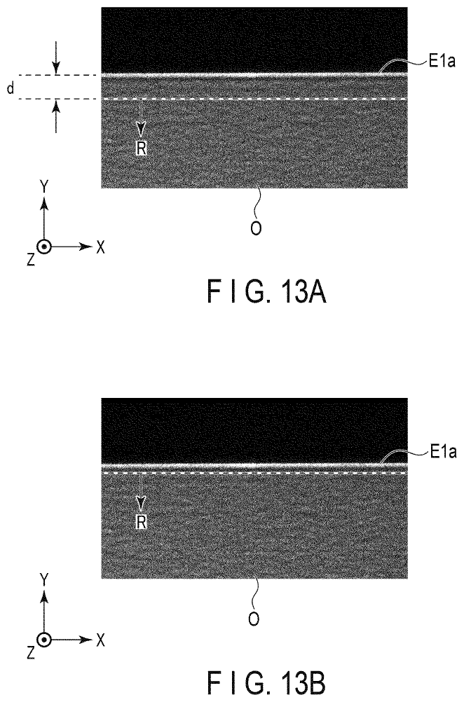

Next, an optical inspection apparatus 1 according to a second embodiment is described with reference to FIG. 13A to FIG. 15. Hereinafter, a description of parts common to the optical inspection apparatus 1 according to the first embodiment is omitted where unnecessary. Here, the configurations illustrated in FIG. 1 and FIG. 2 are applied to the basic configuration of the optical inspection apparatus 1 in the second embodiment.

In the first embodiment, it is assumed that the modulation direction Dm1 of the pattern lights (first modulation pattern lights) is substantially parallel to the extending direction D1 of the end portions E1a, E2a of the object O. However, depending on the shape of the peculiar area S, there may be a case where emphasis is not sufficient in the peculiar light scattering image (first peculiar light scattering image). In one example, it was found that in a case where the peculiar area S has a line shape substantially parallel to the extending direction D1 of the end portions E1a, E2a of the object O, and the modulation direction Dm of the pattern lights is substantially parallel to the extending direction D1 of the end portions E1a, E2a of the object O, the emphasis in the peculiar light scattering image decreases and the extraction accuracy of the peculiar area S deteriorates. On the other hand, in the case of using the pattern lights (second modulation pattern lights) of the modulation direction Dm2 that is nonparallel to the extending direction D1 of the line-shaped peculiar area S, since the peculiar area S is emphasized in the peculiar light scattering image, the optical inspection apparatus 1 can enhance the extraction accuracy of the peculiar area S. Specifically, even in regard to one identical continuous peculiar area S, depending on the modulation direction Dm1, Dm2 of the pattern light, there are a case where the peculiar area S is emphasized in the peculiar light scattering image and a case where the peculiar area S is less easily emphasized in the peculiar light scattering image.

For example, in a case of a crack occurring in the object O, the crack, in many cases, begins from the end portion E1a of the object O, and advances inward from the end portion E1a of the object O to have a line shape. In the vicinity of the end portion E1a of the object O, since the crack is nonparallel to the extending direction of the end portion E1a of the object O, the crack can be extracted as the peculiar area S in the process of the optical inspection apparatus 1 described in the first embodiment. However, there is a case where the direction of the crack further advancing to the inside of the object O becomes substantially parallel to the extending direction D1 of the end portion E1a of the object O. In this case, the crack can be emphasized by the peculiar light scattering image using the pattern lights that are nonparallel to the extending direction D1 of the end portion E1a of the object O.

A description is given of an example in which in the optical inspection apparatus 1 of the second embodiment, in addition to the optical inspection process in the optical inspection apparatus 1 of the first embodiment, the optical inspection process is executed by using pattern lights that are nonparallel to the extending direction D1 of the end portion E1a of the object O.

FIG. 13A and FIG. 13B are diagrams each schematically illustrating a peculiar light scattering image generated by using pattern lights (second modulation pattern lights) that are nonparallel to the extending direction D1 of the end portion E1a of the object O, and an inspection target area R in the peculiar light scattering image. In the case of using the nonparallel pattern lights, by the peculiar scattering due to the end portion E1a of the object O, the end portion E1a of the object O in the peculiar light scattering image appears as a bright part like the peculiar area S, and this leads to erroneous extraction of the peculiar area S.

FIG. 13A illustrates that a position, which is remote from the end portion E1a of the object O by a predetermined distance d or more, is set as the inspection target area R. This method can be adopted in a case where the position of the object O is always unchanged in the acquired image, or in a case where the position of the end portion E1a of the object O can easily be detected by image processing. It is preferable that the predetermined distance d is a maximum value of a variance of the position of the object O in the image acquired in accordance with the irradiation of the pattern light, or a value adaptive to a detection error of the end portion E1a of the object O in the image processing, in addition to the width of the bright part occurring due to the presence of the end portion E1a of the object O. In this manner, by setting the area R, which is remote from the end portion E1a of the object O by the predetermined distance d or more, as the inspection target area, the optical inspection apparatus 1 can extract a desired peculiar area S in the area R1, without detecting the bright part appearing at the end portion E1a of the object O, or by ignoring the bright part even if the bright part is detected, since the bright part is remoted from the area R.

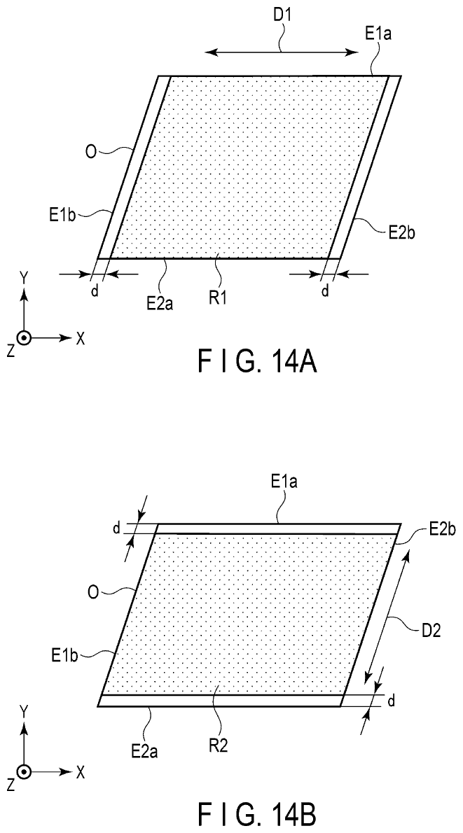

Note that, as illustrated in FIG. 14B, in the inspection target area R, the boundary of the lower-side range on the drawing sheet of FIG. 14B is set at a position that is remote, by a predetermined distance d or more, from the end portion E2a, which is on the opposite side to the end portion E1a of the object O, toward the end portion E1a side.

In addition, as illustrated in FIG. 13B, in the peculiar light scattering image, a portion of the bright part appearing at the end portion E1a of the object O may be detected, and the area toward the end portion E2a on the opposite side to the end portion E1a, excluding the bright part, can be set as the upper end on the drawing sheet in FIG. 14B in the inspection target area R. Similarly, in the peculiar light scattering image, a portion of the bright part appearing at the end portion E2a of the object O may be detected, and the area toward the end portion E1a on the opposite side to the end portion E2a, excluding the bright part, can be set as the lower end on the drawing sheet in FIG. 14A in the inspection target area R. The bright part appearing at the end portions E1a, E2a of the object O can be detected, for example, by setting a certain threshold and determining a continuously extending area that is equal to or greater than the threshold. In addition, by performing image processing, the area excluding the detected bright part is set as the inspection target area R, and the range in which a desired peculiar area S can be extracted can be set. In the case of the example illustrated in FIG. 13B, compared to the example illustrated in FIG. 13A, the inspection target area R can be set to be larger.

By setting the modulation direction Dm2 of the nonparallel pattern lights to be the direction substantially parallel to the other end portions E1b, E2b of the object O, the entirety of the object O can be covered as the inspection target area R, and the number of pattern lights to be projected can be made smaller than in the case of projecting pattern lights in random modulation directions.

FIG. 14A and FIG. 14B schematically illustrate examples of a setting range of an inspection target area R of an inspection that is performed by using pattern lights in regard to the object O having an outer shape (end portion) of a parallelogram. FIG. 14A illustrates an example of using pattern lights (first modulation pattern lights) having the first modulation direction Dm1 described in the first embodiment, which is substantially parallel to the extending direction D1 of the upper end portion E1a and lower end portion E2a. It is assumed that a peculiar light scattering image generated by projecting the pattern lights having the first modulation direction Dm1 is S1(m, n). In the peculiar light scattering image S1(m, n), no bright part occurs at the upper end portion E1a and lower end portion E2a in FIG. 14A. However, since the modulation direction Dm1 is nonparallel to the extending direction D2 of the left end portion E1b and right end portion E2b in FIG. 14A, a position corresponding to the end portions E1b, E2b of the peculiar light scattering image S1(m, n) becomes a bright part. Here, an inside area remote from each of the left end portion E1b and right end portion E2b by a certain distance d is set to be a first inspection target area R1.

FIG. 14B illustrates an example of using pattern lights (second modulation pattern lights) having the second modulation direction Dm2, which is substantially parallel to the extending direction D2 of the left end portion E1b and right end portion E2b. It is assumed that a peculiar light scattering image generated by projecting the pattern lights having the second modulation direction Dm2 is S2 (i, n). In the peculiar light scattering image S2 (i, n), no bright part occurs at the left end portion E1b and right end portion E2b in FIG. 14B. However, since the modulation direction Dm2 is nonparallel to the upper end portion E1a and lower end portion E2a in FIG. 14B, a position corresponding to the end portions E1a, E2a of the peculiar light scattering image S2(m, n) becomes a bright part. Here, an inside area remote from each of the upper end portion E1a and lower end portion E2a by a certain distance d is set to be a second inspection target area R2.

Note that an area of a combination of the first inspection target area R1 and the second inspection target area R2 is the entirety of the front surface and back surface of the object O.

In this manner, in the case of using the pattern lights of two different modulation directions Dm1 and Dm2, the result of the combination of the peculiar area extracted by using the peculiar light scattering image S1(m, n) and the peculiar area extracted by using the peculiar light scattering image S2(m, n) can be extracted as the peculiar area S of the object O according to the present embodiment. In this case, in the area where the inspection target area R1 by the first modulation direction Dm1 and the inspection target area R2 by the second modulation direction Dm2 overlap, extraction that is less dependent on the shape of the peculiar area S can be performed. Thus, the optical inspection apparatus 1 can more exactly extract the peculiar area S. Specifically, although there is a case where a part of an extracted peculiar area and a part of an extracted peculiar area are different, these can be extracted, respectively, if the pattern lights of the two different modulation directions Dm1 and Dm2 are used.

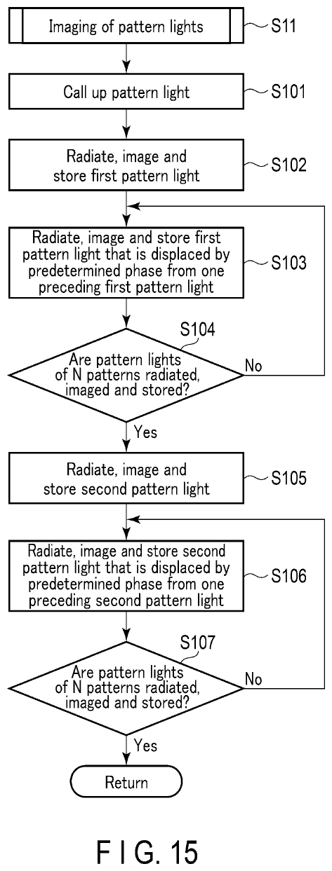

FIG. 15 is a flowchart illustrating an optical inspection method that is executed by using the optical inspection apparatus 1 according to the second embodiment. The operation of FIG. 15 can be controlled by the controller 31 of the control device 30. The process of FIG. 15 is a modification of the imaging process of pattern lights in step S11 of FIG. 8 described in the first embodiment. The basic flow of the optical inspection apparatus 1 according to the second embodiment is the same as the flow of the optical inspection apparatus 1 according to the first embodiment illustrated in FIG. 7.

Steps S101 to S104 of step S11 are the same as the flow of the optical inspection apparatus 1 described in the first embodiment. Note that each image of the first image group is acquired as an image of an area including the four end portions of the object O, and, as illustrated in FIG. 14A, for example, the area, which is remote from the left end portion E1b by the distance d or more and located on the right side of the position of the distance d, and is remote from the right end portion E2b by the distance d or more and located on the left side of the position of the distance d, is set as a detection range R1.

The controller 31 causes the projector 10 to project, onto the object O, one of the pattern lights (light along the direction D2 corresponding to the pattern light Ii0 in FIG. 3A) having the modulation direction Dm2, which is nonparallel to the extending direction D1 of the upper end portion E1a and lower end portion E2a of the object O and is parallel to the extending direction D2 of the left end portion E1b and right end portion E2b, and the controller 31 causes the imaging device 20 to image the pattern light passing through the object O, and causes the storage unit 32 to store the image thereof (pattern image Io0) (step S105). The image (pattern image Io0) becomes one image of the second image group.

Pattern light (light along the direction D2 corresponding to the pattern light Ii1 illustrated in FIG. 3A), which is displaced by a predetermined phase from one preceding radiated pattern light (light along the direction D2 corresponding to the pattern light Ii0 illustrated in FIG. 3A), is projected onto the object O, and the controller 31 causes the imaging device 20 to image the pattern light passing through the object O, and causes the storage unit 32 to store the image thereof (pattern image Io1) (step S106). The image (pattern image Io1) becomes one image of the second image group.

In addition, the controller 31 determines whether the pattern lights of predetermined N patterns (N is an integer of three or more; N is assumed to be 4 in this example) were projected onto the object O, the imaging device 20 was caused to image the pattern lights of the predetermined N patterns, and the storage unit 32 was caused to store the images thereof (step S107). If the pattern lights of the predetermined N patterns (for example, four patterns) were not projected onto the object O (step S107-No), pattern light (light along the direction D2 corresponding to the pattern light Ii2 illustrated in FIG. 3A), which is displaced by a predetermined phase from one preceding radiated pattern light (light along the direction D2 corresponding to the pattern light Ii1 illustrated in FIG. 3A), is projected onto the object O, and the controller 31 causes the imaging device 20 to image the pattern light passing through the object O, and causes the storage unit 32 to store the image thereof (pattern image Io2). The image (pattern image Io2) becomes one image of the second image group.

Pattern light (light along the direction D2 corresponding to the pattern light Ii3 illustrated in FIG. 3A), which is displaced by a predetermined phase from one preceding radiated pattern light (light along the direction D2 corresponding to the pattern light Ii2 illustrated in FIG. 3A), is projected onto the object O, and the controller 31 causes the imaging device 20 to image the pattern light passing through the object O, and causes the storage unit 32 to store the image thereof (pattern image Io3). The image (pattern image Io3) becomes one image of the second image group.

If the pattern lights of the predetermined N patterns are projected onto the object O, the imaging device 20 is caused to image the pattern lights, and the storage unit 32 is caused to store the images thereof (step S107-Yes), the process illustrated in FIG. 15 is terminated, that is, the process of step S11 by the controller 31 of the optical inspection apparatus 1 as illustrated in FIG. 7 is terminated, and the controller 31 subsequently executes a process of step S12.

Note that in the present embodiment, the example was described in which different pattern lights are radiated multiple times, imaged and stored. As described with reference to FIG. 12, for example, first pattern lights, which are one set of, for example, three lights displaced by λ/4, may be made to have different wavelengths, and use can be made of the image sensor 22 that separates RGB into spectral components and acquires images thereof. In this case, the first pattern lights, which are one set of, for example, three lights displaced by λ/4, are radiated in the same period, imaged and stored, and second pattern lights, which are one set of, for example, three lights displaced by λ/4, are radiated in the same period, imaged and stored, and thereby the process of step S11 by the controller 31 of the optical inspection apparatus 1 can be executed.

Note that each image of the second image group is acquired as an image of an area including the four end portions E1a, E2a, E1b and E2b of the object O, and, as illustrated in FIG. 14B, for example, the area, which is on the lower side of the position of the distance d from the upper end portion and is on the upper side of the position of the distance d from the lower end portion, is set as a detection range R2, i.e., the area that is the target of the peculiar area extraction process.

In step S12, as a peculiar area extraction process, the controller 31 generates a peculiar light scattering image (first peculiar light scattering image) in the detection range R1 illustrated in FIG. 14A by using N (here, N=4) photographed images (pattern images) Io0, Io1, Io2 and Io3 of the first image group, and also generates a peculiar light scattering image (second peculiar light scattering image) in the detection range R2 illustrated in FIG. 14B by using N (here, N=4) photographed images (pattern images) Io0, Io1, Io2 and Io3 of the second image group.

In step S13, the controller 31 outputs two peculiar light scattering images (first peculiar light scattering image and second peculiar light scattering image) as the inspection images relating to the object O. For example, the controller 31 causes the display of the output device 37 to display the inspection images. Alternatively, the controller 31 transmits the inspection images to an analysis device (image processing apparatus) that is not illustrated, by using the communication interface 35. In this manner, the controller 31 of the optical inspection apparatus 1 terminates the serial process (optical inspection method) relating to the optical inspection, which is illustrated in FIG. 7 and FIG. 15.

Note that, as described in the first embodiment, the analysis device can analyze the presence/absence of a defect such as a crack, by comparing each pixel of the inspection image (first peculiar light scattering image) designating the detection range R1 and the inspection image (second peculiar light scattering image) designating the detection range R2 with a prestored threshold representing the peculiar area S.

Alternatively, the analysis device can analyze the presence/absence of a defect such as a crack, by comparing each pixel of one image, in which the detection range R1 of the first peculiar light scattering image and the detection range R2 of the second peculiar light scattering image are overlapped, with a prestored threshold representing the peculiar area S.

In the present embodiment, the description was given such that after the first image group is acquired by the first pattern lights having the modulation direction Dm1 that is substantially parallel to the extending direction D1 of the end portions E1a, E2a of the object O, the second image group is acquired by the second pattern lights having the modulation direction Dm2 that is nonparallel to the extending direction D1 of the end portions E1a, E2a of the object O, such as across the direction D1, and is substantially parallel to the extending direction D2 of the end portions E1b, E2b of the object O. The controller 31 of the optical inspection apparatus 1 may acquire, for example, the first image group after first acquiring the second image group. In addition, the controller 31 of the optical inspection apparatus 1 may first acquire, for example, some images of the first image group, may then acquire some images of the second image group, and may thereafter acquire the other images of the first image group. Thus, the order for acquiring both the first image group and the second image group may be random or may be set as appropriate.

As has been described above, in the optical inspection apparatus 1 according to the second embodiment, a plurality of pattern lights (first modulation pattern lights) having the modulation direction Dm1 substantially parallel to the extending direction D1 of the end portions E1a, E2a of the object O are projected onto the object O, and the first peculiar light scattering image is generated from a plurality of images acquired by imaging the object O. In the first peculiar light scattering image, there occurs no peculiar bright part due to the end portion of the object O, and only the peculiar area S can be emphasized. Further, in the optical inspection apparatus 1 according to the second embodiment, a plurality of pattern lights (second modulation pattern lights) having the modulation direction Dm2, which is nonparallel to the extending direction D1 of the end portions E1a, E2a of the object O and is parallel to the extending direction D2 of the end portions E1b, E2b of the object O, are projected onto the object O, and the second peculiar light scattering image, which is different from the first peculiar light scattering image, is generated from a plurality of images acquired by imaging the object O. In the second peculiar light scattering image, the area R2 in the inside of the peculiar bright part due to the end portions E1a, E2a of the object O is set to be the inspection target area, and thereby the extraction accuracy of the peculiar area S in the inspection target area can be enhanced.

The controller 31 of the optical inspection apparatus 1 according to the present embodiment projects, onto the object O, the second modulation pattern lights that have the modulation direction nonparallel to the direction of the end portions E1a, E2a of the object O, and have the intensity modulation pattern with the different modulation direction from the first modulation pattern lights, and images the object O onto which the second modulation pattern lights are projected, thereby acquiring the second image group. In addition, the controller 31 generates, by the peculiar scattering extraction process, the second peculiar light scattering image that can include an image of the peculiar area S that is located at the position remote from the end portions E1a, E2a of the object O by the distance d or more, is extracted based on the second image group, and causes peculiar light scattering due to the second modulation pattern lights.

Besides, according to the present embodiment, the controller 31 detects the peculiar area S of the object O by using the second peculiar light scattering image. Thus, there is provided the optical inspection apparatus 1 that can prevent erroneous detection of a peculiar area S, such as a defect, of the object O near the end portions E1a, E2a of the object O.

Thus, according to the present embodiment, there can be provided the optical inspection apparatus 1, optical inspection method and optical inspection program, which can prevent erroneous detection of a peculiar area S such as a defect.

In the present embodiment, it is assumed that the number of pattern lights having different modulation directions is two, i.e., the modulation directions are two directions Dm1 and Dm2. However, the embodiment is not limited to this, and three or more pattern lights may be used, and three or more modulation directions may be set. For example, in the case of optically inspecting the object O having a trapezoidal outer shape, first modulation pattern lights having an intensity modulation pattern with the modulation direction Dm1 substantially parallel to the extending direction of a pair of parallel end portions are projected onto the object, first modulation pattern lights having an intensity modulation pattern with the modulation direction Dm2 substantially parallel to the extending direction of one end portion of the other two end portions are projected onto the object, first modulation pattern lights having an intensity modulation pattern with a modulation direction Dm3 (not illustrated) substantially parallel to the extending direction of the other end portion are projected onto the object, and images thereof are acquired. Thereby, there can be provided the optical inspection apparatus 1, optical inspection method and optical inspection program, which can prevent erroneous detection of a peculiar area such as a defect.

### Modification

In the second embodiment, the example in which the outer shape of the object O is rectangular was described.

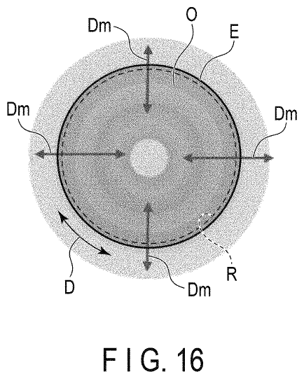

FIG. 16 illustrates an object O having a circular outer edge, like the object O illustrated in FIG. 10. In addition, FIG. 16 illustrates pattern lights having a modulation direction Dm that is a radial direction of the object O, unlike the modulation direction Dm illustrated in FIG. 10 that is a circumferential direction of the end portion E of the object O.

The controller 31 of the optical inspection apparatus 1 acquires, according to the example illustrated in FIG. 10, the first image group by the pattern lights (first modulation pattern lights) having the modulation direction Dm that is substantially parallel to the extending direction D of the end portion E of the object O. In addition, the controller 31 of the optical inspection apparatus 1 acquires, according to the example illustrated in FIG. 16, the second image group by the pattern lights (second modulation pattern lights) having the modulation direction Dm that is nonparallel to the extending direction D of the end portion E of the object O. Accordingly, the controller 31 outputs two peculiar light scattering images (first peculiar light scattering image and second peculiar light scattering image) as inspection images relating to the object O. At this time, in the first peculiar light scattering image of the example illustrated in FIG. 10, the entire surface including the end portion E of the object O is the inspection target area R. In addition, a peculiar area S, excluding the end portion E and a peculiar area S parallel to the extending direction D of the end portion E, can be detected by the first peculiar light scattering image by the pattern lights having the modulation direction Dm parallel to the extending direction D of the end portion E of the object O. On the other hand, in the second peculiar light scattering image of the example illustrated in FIG. 16, the area in the inside of the position, which is remote from the end portion E of the object O by a predetermined distance d, is the inspection target area R. In addition, the peculiar area S, excluding a peculiar area S extending in a direction perpendicular to the extending direction D of the end portion E, can be detected by the second peculiar light scattering image by the pattern lights having the modulation direction Dm that is perpendicular to the extending direction D of the end portion E of the object O and is parallel to the radial direction.

Thus, according to the present modification, there can be provided the optical inspection apparatus 1, optical inspection method and optical inspection program, which can prevent erroneous detection of a peculiar area S such as a defect.

According to the optical inspection apparatus 1, optical inspection method and optical inspection program of at least one of the above-described embodiments, erroneous detection of a peculiar area such as a defect can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical inspection apparatus comprising:
a controller, the controller being configured to:
project first modulation pattern lights having an intensity modulation pattern, in which an extending direction of an end portion of an object and a modulation direction are substantially parallel, onto the object;
acquire a first image group by imaging the object onto which the first modulation pattern lights are projected; and
generate, by a peculiar scattering extraction process, a first peculiar light scattering image that is able to include an image of a peculiar area that is located at the end portion of the object or in an area inside the end portion, is extracted based on the first image group, and causes peculiar light scattering due to the first modulation pattern lights.

2. The optical inspection apparatus of claim 1, wherein the controller is configured to detect the peculiar area of the object by using the first peculiar light scattering image.

3. The optical inspection apparatus of claim 1, wherein the controller is configured to:
project, onto the object, second modulation pattern lights having a modulation direction nonparallel to the direction of the end portion of the object, the second modulation pattern lights having an intensity modulation pattern with the modulation direction different from the modulation direction of the first modulation pattern lights;
acquire a second image group by imaging the object onto which the second modulation pattern lights are projected; and
generate, by the peculiar scattering extraction process, a second peculiar light scattering image that is able to include an image of a peculiar area that is located at a position remote from the end portion of the object by a certain distance or more, is extracted based on the second image group, and causes peculiar light scattering due to the second modulation pattern lights.

4. The optical inspection apparatus of claim 3, wherein the controller is configured to detect the peculiar area of the object by using the second peculiar light scattering image.

5. The optical inspection apparatus of claim 1, wherein the peculiar scattering extraction process of the controller is a process of computing a modulation amplitude at each of pixel points.

6. The optical inspection apparatus of claim 1, wherein the intensity modulation pattern is a cyclic modulation pattern.

7. The optical inspection apparatus of claim 1, further comprising:
a projector configured to be controlled by the controller and to project the first modulation pattern lights onto the object; and
an imaging device configured to be controlled by the controller and to acquire the first image group.

8. An optical inspection method comprising:
projecting first modulation pattern lights having an intensity modulation pattern, in which an extending direction of an end portion of an object and a modulation direction are substantially parallel, onto the object;
acquiring a first image group by imaging the object onto which the first modulation pattern lights are projected; and
generating, by a peculiar scattering extraction process, a first peculiar light scattering image that is able to include an image of a peculiar area that is located at the end portion of the object or in an area inside the end portion, is extracted based on the first image group, and causes peculiar light scattering due to the first modulation pattern lights.

9. The optical inspection method of claim 8, further comprising detecting the peculiar area of the object by using the first peculiar light scattering image.

10. The optical inspection method of claim 8, further comprising:
projecting, onto the object, second modulation pattern lights having a modulation direction nonparallel to the direction of the end portion of the object, the second modulation pattern lights having an intensity modulation pattern with the modulation direction different from the modulation direction of the first modulation pattern lights;
acquiring a second image group by imaging the object onto which the second modulation pattern lights are projected; and
generating, by the peculiar scattering extraction process, a second peculiar light scattering image that is able to include an image of a peculiar area that is located at a position remote from the end portion of the object by a certain distance or more, is extracted based on the second image group, and causes peculiar light scattering due to the second modulation pattern lights.

11. The optical inspection method of claim 10, further comprising detecting the peculiar area of the object by using the second peculiar light scattering image.

12. A non-transitory storage medium storing an optical inspection program that causes a computer to execute:
projecting first modulation pattern lights having an intensity modulation pattern, in which an extending direction of an end portion of an object and a modulation direction are substantially parallel, onto the object;
acquiring a first image group by imaging the object onto which the first modulation pattern lights are projected; and
generating, by a peculiar scattering extraction process, a first peculiar light scattering image that is able to include an image of a peculiar area that is located at the end portion of the object or in an area inside the end portion, is extracted based on the first image group, and causes peculiar light scattering due to the first modulation pattern lights.

13. The non-transitory storage medium storing the optical inspection program of claim 12, the optical inspection program further causing the computer to execute detecting the peculiar area of the object by using the first peculiar light scattering image.

14. The non-transitory storage medium storing the optical inspection program of claim 12, the optical inspection program further causing the computer to execute:
projecting, onto the object, second modulation pattern lights having a modulation direction nonparallel to the direction of the end portion of the object, the second modulation pattern lights having an intensity modulation pattern with the modulation direction different from the modulation direction of the first modulation pattern lights;
acquiring a second image group by imaging the object onto which the second modulation pattern lights are projected; and
generating, by the peculiar scattering extraction process, a second peculiar light scattering image that is able to include an image of a peculiar area that is located at a position remote from the end portion of the object by a certain distance or more, is extracted based on the second image group, and causes peculiar light scattering due to the second modulation pattern lights.

15. The non-transitory storage medium storing the optical inspection program of claim 14, the optical inspection program further causing the computer to execute detecting the peculiar area of the object by using the second peculiar light scattering image.
